(19) United States
(12) Patent Application Publication
(10) Pub. No.: US 2018/0139946 A1
(43) Pub. Date: May 24, 2018

(54) Termite Baiting Assembly

(71) Applicant: Joseph T. Wright, Wichita, KS (US)

(72) Inventor: Joseph T. Wright, Wichita, KS (US)

(21) Appl. No.: 15/873,509

(22) Filed: Jan. 17, 2018

(51) Int. Cl. A01M 1/20; A01M 1/02

(52) U.S. Cl. CPC A01M 1/2011; A01M 2200/011; A01M 1/026

(57) ABSTRACT

An assembly for termite baiting beneath a ground surface, the assembly incorporating a barrier plate positioned upon the ground surface; a thermal shadow cast by the barrier plate, the thermal shadow having a lateral periphery, wherein the casting of the thermal shadow extends the thermal shadow downwardly into the ground from the barrier plate; a plurality of pine wood stakes having upper ends, the wooden stakes extending into the ground from the barrier plate and being positioned by the barrier plate at the thermal shadow's lateral periphery; a plurality of mounting caps interconnecting the wooden stakes' upper ends and the barrier plate; and a termiticide body buried beneath the barrier plate and within the thermal shadow.

### FIELD OF THE INVENTION

This invention relates to apparatus and assemblies for insect and pest control. More particularly, this invention relates to such assemblies which are adapted for facilitating termiticide baiting control of termites at shallow subterranean locations surrounding a building in need of termite protection.

### BACKGROUND OF THE INVENTION

Ground tunneling termites or subterranean termites such as those within the family Rhinotermitidae commonly horizontally extend exploratory tunnels at shallow levels beneath the ground surfaces in search of wood upon which they may feed. Insect behavior studies have determined that termite such exploratory tunneling generally continues horizontally through zones where moisture and temperature remains relatively constant in relation to surrounding ground areas. In contrast, termites generally dwell at and extend ancillary branching tunnels in the event that an exploratory tunnel enters a subterranean zone having a relatively low temperature and relatively high moisture content.

A common cause of such ground areas of decreased temperature and increased moisture is thermal shadowing which may underlie a fallen wooden log. Radiant heat from the sun tends to heat such fallen log instead of directly heating the underlying ground materials, resulting in a lowering of the temperature of the ground beneath the log with respect to surrounding ground areas. The lowered temperature of the ground beneath the log lessens the effects of the sunlight in drying moisture from the ground, resulting in a relative increase in the moisture content of the ground beneath the log. The log itself further increases underlying moisture content by functioning as an evaporation barrier.

Upon the termites' tunneling entry into such subterranean zone of relatively low temperature and relatively high moisture, the termites sense the change and dwell in the low temperature/high moisture zone. While in such zone, the termites extend localized exploratory tunnels in various directions to determine whether consumable wood is present in the area. Upon finding no food source within the low temperature/high moisture zone, such as may occur when a stone produces the underlying moisture and temperature differential, the termites typically depart and carry on with their horizontal exploratory tunneling. Alternatively, upon finding a wooden food source within the low temperature/high moisture zone, the termites typically establish a local feeding site within the zone to feed upon the wooden food surface.

The instant inventive assembly for termite baiting works consonantly with and takes advantage of the above described instinctual phenomena of termite sensing of zones of low temperature and high moisture and instinctual correlation of such sensed zones with the presence of a food source by providing a specialized barrier plate which is adapted to multiply function for creation of an underlying thermal shadow within the ground, for serving as a moisture evaporation barrier, and for serving as means for extending and supporting wooden bait sticks.

### BRIEF SUMMARY OF THE INVENTION

A first structural component of the instant inventive assembly for subterranean termite baiting comprises a barrier plate. In a preferred embodiment, the barrier plate component is composed of plastic and is configured as a circular disk. In the preferred embodiment, the barrier plate has a diameter between 4″ and 7″, and has a vertical thickness between ⅛″ and ½″. Other geometric configurations of the barrier plate such as square, rectangular, oval, pentagonal, hexagonal, and octagonal are considered to fall within the scope of the invention.

Further structural components of the instant inventive assembly comprise a plurality of wooden stakes which are fixedly attached to and extend downwardly into the ground from the barrier plate component. Mounting means for interconnecting upper ends of the wooden stakes with the barrier plate are provided, such means preferably comprising combinations of apertures through the plate and flanged caps which extend through such apertures and upwardly receive the upper ends of the wooden stakes. In order to effectively perform their alternative functions as a termite attracting food source, the wooden stakes preferably comprise pine wood. Other means for interconnecting the upper ends of the wooden stakes with the barrier plate such as wholly formed stake receiving sockets, screw connections, and stake head receiving apertures are considered to fall within the scope of the invention.

In use of the instant inventive assembly, a homeowner may initially dig a shallow pit with a spade within the ground at a point near a wall of his or her home. In a preferred embodiment, such pit is approximately 3″ in diameter, and is approximately 4″ to 6″ deep. Thereafter, the homeowner may place within such pit a body of termiticide such as diflubenzuron, noviflumuron, imidocloprid, fipronil, chlorfenapyr, lufenuron, hydramethylnon, sulfuramid, or hexaflumuron. In a preferred embodiment, such termiticide material is contained within a loosely woven bag or sack such as a burlap enclosure which will allow through passage and ingress of termites. Thereafter, the homeowner may place such termiticide body within the pit, and refill the pit with dirt to ground level.

Thereafter, the homeowner may place the invention's barrier plate component over the pit, and may successively hammer provided pine wood stakes downwardly through eyes or apertures within the plate. Preferably, socket caps are preliminarily provided and are placed over the heads of such stakes to facilitate downward hammering of the stakes and to facilitate secure pressure fitted connections between the upper ends of the stakes and the apertures within the barrier plate.

In operation, the barrier plate slows transmission of solar radiant heat to the ground at and about a thermal shadow zone underlying the plate, resulting in a relatively low ground temperature beneath the plate. Simultaneously, the barrier plate functions as a moisture evaporation barrier, heightening the relative moisture of the ground beneath the plate.

In the event that termites extend an exploratory horizontal tunnel through the ground to the location of such thermal shadow, the termites naturally detect the lower relative temperature at such zone and detect the soil's increased moisture content. Upon sensing the low temperature and high moisture, the termites dwell within the thermal shadow zone and begin to feed upon the wooden stake feed food sources. Such wooden stake food sources are advantageously aligned by the barrier plate so that they reside at the periphery of the thermal shadow zone which preferably centrally includes the buried body of termiticide. Accordingly, the termites naturally additionally feed upon the termiticide body, resulting in termite extermination and protection in the manner of the operation of the particularly selected termiticide.

Accordingly, objects of the instant invention include the provision of an assembly for termite baiting beneath a ground surface which incorporates structures as described above, and which arranges those structures in manners described above, for the achievement of the beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of assembled plate and stake components of the instant inventive assembly for termite baiting.

FIG. 2 is a separated perspective view of the plate component of the structure of FIG. 1.

FIG. 3 is a sectional view as indicated in FIG. 1.

FIG. 4 redepicts the structure of FIG. 3, the view of FIG. 4 showing structures of the assembly in their use environment.

### DETAILED DESCRIPTION OF A PREFERRED EMBODIMENT

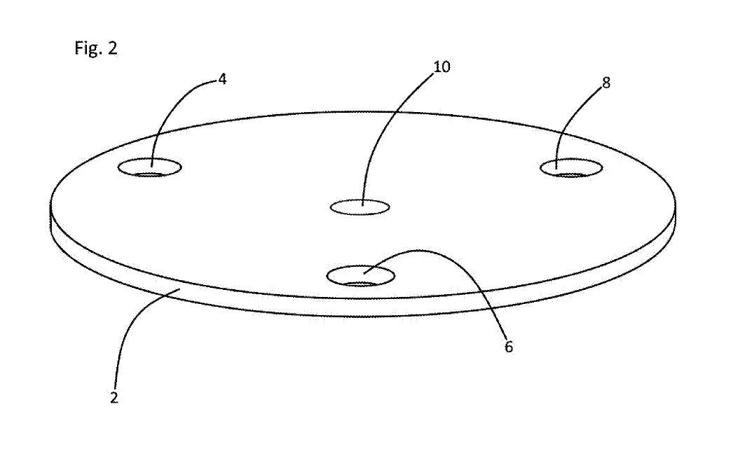

Referring now to the drawings, and in particular to Drawing FIG. 2, a barrier plate component of the instant inventive termite baiting assembly is referred to generally by Reference Numeral 2. As depicted, the barrier plate 2 is circular, having a diameter between 4″ and 7″ and having a thickness between ⅛″ and ½″. The barrier plate 2 is preferably composed of plastic, and its preferred circular configuration is intended as being representative of other geometric shapes such as squares, hexagons, ovals, and the like. Peripheral wooden stake engaging apertures or eyes 4, 6, and 8 extend vertically through the barrier plate 2, and such plate preferably additionally includes a centrally positioned anchor stake aperture 10.

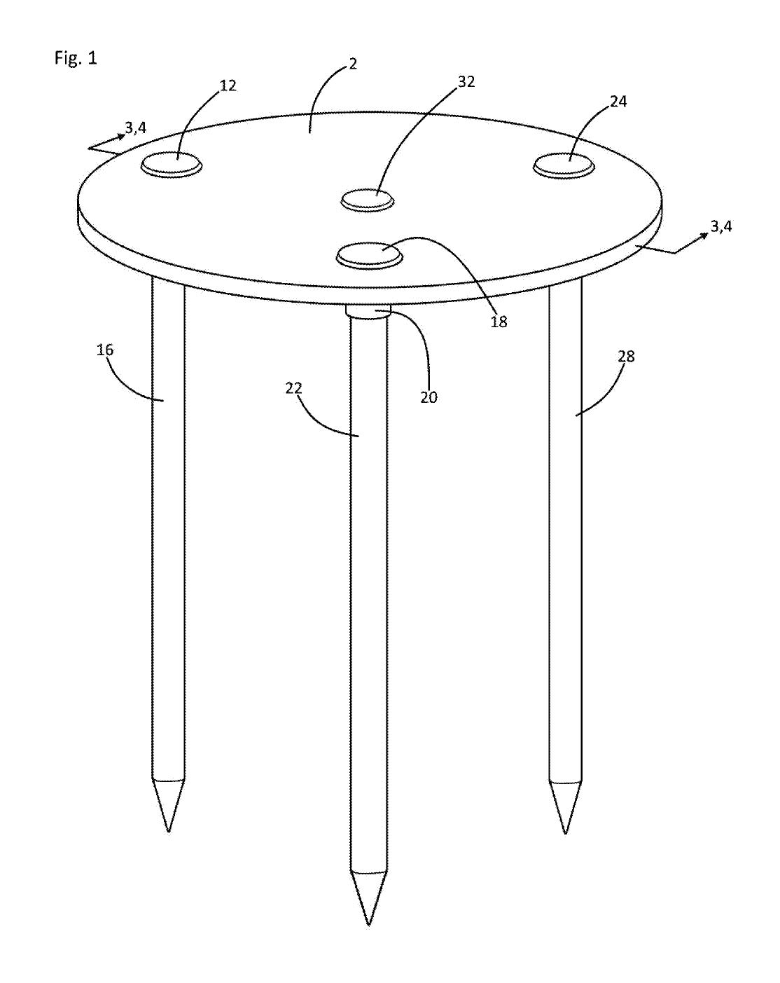

Referring simultaneously to FIGS. 1-3, wooden stakes 16, 22, and 28, are provided. Each of the stakes 16, 22, 28 preferably has a pointed lower end, and has an upper end which is held in engagement with the barrier plate 2. In addition to their plate anchoring and positioning functions, the stakes 16, 22, and 28 perform a function of providing a localized source of food for termites which causes them to dwell or remain at a subterranean locale directly underlying the barrier plate 2. Termites are known to feed upon pine wood and, in furtherance of their food source providing function, the stakes 16, 22, and 28 are preferably composed of pine wood.

Preferred means for attaching the upper ends of stakes 16, 22, and 28 to the barrier plate 2 comprise the apertures 4, 6, and 8 in combination with flanged caps 12, 18, and 24. In the preferred embodiment, such caps respectively present downwardly opening sockets 14, 20, and 26. The outside diameter of socket 14 is preferably closely fitted to the inside diameter of aperture 4, while the inner wall of socket 14 is preferably slightly conically sloped in order to establish a tight pressure fit connection with the upper end of stake 16. Flanged cap 18 having socket 20 is preferably similarly configured for downward receipt within aperture 6 and for secure holding the upper end of stake 22. The assembly's third cap and socket combination 24,26 is similarly configured for engagements with aperture 8 and the upper end of stake 28.

The above described aperture and cap combinations are considered to be representative of other suitably substituted stake mounting means such as screw connections, wholly formed sockets, pressure fitted eyes, and the like.

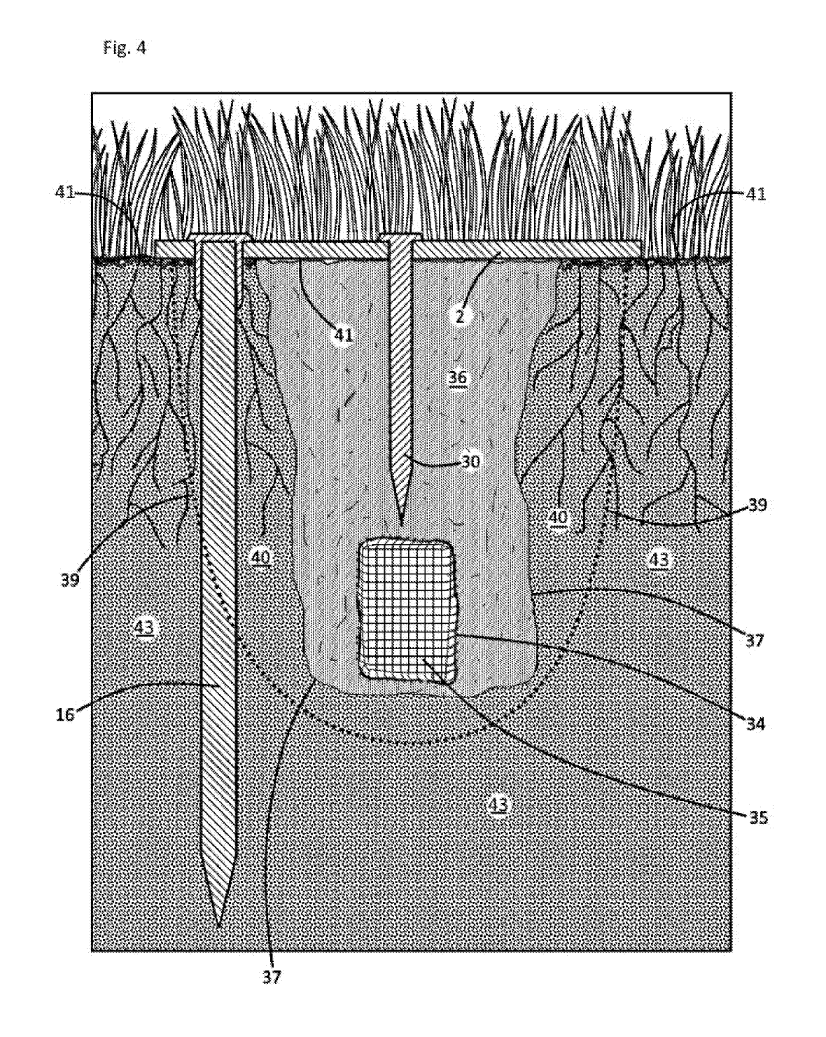

In use of the instant inventive assembly, and referring in particular to Drawing FIG. 4, a ground surface area 41 near the outer wall of a home to be protected by the instant inventive assembly is identified. At such ground area 41, a circular area of grass 3 may be cut by a homeowner to the level of the ground, such circular area matching the circular profile of the barrier plate 2. Thereafter, the homeowner may utilize a hand spade to dig a small pit 37 having a diameter of approximately 3″ and having a depth between 4″ and 6″.

Thereafter, the homeowner may drop a provided body of termiticide 34 into the excavated pit 37, such body of termiticide 34 preferably comprising a mixture of diflubenzuron, noviflumuron, imidocloprid, fipronil, chlorfenapyr, lufenuron, hydramethylnon, sulfuramid, or hexaflumuron, and a termite edible inactive ingredient. In the preferred embodiment, the termiticide is encapsulated within a bag or closure 35 which is composed of a loosely woven natural fiber such as cotton, hemp, or burlap, which will allow through passage and ingress into the closure by termites.

Thereafter, the homeowner may refill the pit 37 with dirt 36, burying the termiticide body 34. Thereafter, the homeowner may place the barrier plate 2 over the refilled pit 37, and may align the plate 2 so that its apertures 4, 6, and 8 peripherally surround the pit's upper edge.

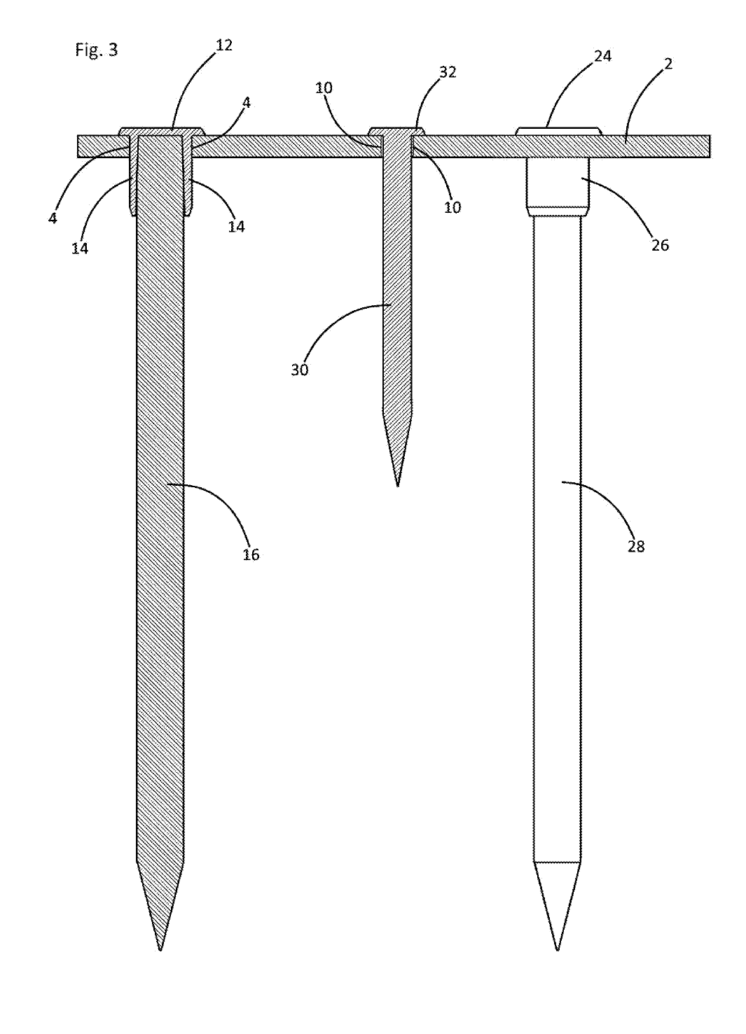

Thereafter, the homeowner may grasp wooden stake 16 and may cover the upper end of such stake with the socket 14 of flanged cap 12. Thereafter, the homeowner may extend the lower point of stake 16 through aperture 4, and may utilize a hammer to percussively strike the upper surface of the cap 12 and to drive the stake 16 and cap 12 downwardly until the socket 14 is nestingly received within aperture 4 as indicated in Drawing FIGS. 3 and 4. During such stake hammering operation, the barrier plate 2 advantageously functions as a stake placement guiding template which assures that the stake 16 resides at the lateral periphery 39 of a thermal shadow zone 40 which is downwardly cast by the barrier plate into the ground 43.

Stakes 22 and 28, and caps 18 and 24, may be similarly downwardly driven through apertures 6 and 8. Upon such downward driving of stakes 16, 22, and 28, such stakes advantageously perform additional functions of securely holding the barrier plate 2 and the associated thermal shadow zone 40 in volumetric alignment with the termiticide body 34.

Upon installation as indicated in FIG. 4, the barrier plate 2 additionally advantageously functions as a moisture evaporation barrier. The barrier plate's dual functions of producing and downwardly casting the thermal shadow zone 40 and blocking evaporation of ground moisture advantageously produce localized temperature and moisture subterranean environment factors which are sensed by termites which extend exploration tunnels in the vicinity.

Termites may naturally horizontally extend such subterranean exploratory tunnels through the ground 43, and may randomly direct such a tunnel toward the thermal shadow zone 40. Upon an extension of such a tunnel into zone 40, the relatively low temperature and high moisture within such zone causes the termites to dwell in the zone and to extend branching ancillary tunnels within such zone. Termites which tunnel near zone 40 naturally dwell at the zone and commence eating the pine wood stakes 16, 22, and 28, which held and positioned by plate 2 at the lateral periphery 39 of the zone 40. Termites feeding upon stakes 16, 22, and 28 within zone 40 naturally additionally feed upon the termiticide body 34 which is centrally positioned within zone 40. Such termites carry termiticide back to central hive areas, transmitting termiticide to other termites which interferes with termite reproductive cycles within the hive or directly acts as a termite killing biocide.

Termite feeding upon the pine wood stakes 16, 22, and 28 may eventually leave the barrier plate 2 unsecured and subject to becoming displaced away from the ground surface 41. In order to prevent such displacement of the barrier plate 2, the central ground stake aperture 10 may receive a downwardly driven plastic stake 30 having a plate retaining flanged head 32.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

1. An assembly for termite baiting beneath a ground surface, said assembly comprising:
(a) a barrier plate positioned upon the ground surface;
(b) a thermal shadow having a lateral periphery, the thermal shadow being cast by the barrier plate into the ground;
(c) a plurality of wooden stakes having upper ends, said stakes extending into the ground from the barrier plate and being positioned by the barrier plate at the thermal shadow's lateral periphery;
(d) mounting means interconnecting the wooden stakes' upper ends and the barrier plate; and
(e) a termiticide body buried within the thermal shadow.

2. The assembly of claim 1 wherein the mounting means comprise a plurality of cap and plate aperture combinations, wherein each of said combinations' caps comprises a downwardly opening socket which is fitted for receiving the upper end of one of the wooden stakes.

3. The assembly of claim 2 wherein each combination among the cap and plate aperture combinations comprises a plate aperture which is fitted for receiving one of the downwardly opening sockets.

4. The assembly of claim 1 wherein each wooden stake comprises pine wood.

5. The assembly of claim 4 wherein the barrier plate and the caps are composed of plastic.

6. The assembly of claim 5 further comprising an anchor stake fixedly attached to and extending downwardly from the barrier plate.

7. The assembly of claim 6 wherein the anchor stake is composed of plastic.

8. The assembly of claim 7 wherein the termiticide body is contained within a natural fiber sack.

9. The assembly of claim 8 wherein the termiticide body comprises an insecticide selected from the group consisting of diflubenzuron, noviflumuron, imidocloprid, fipronil, chlorfenapyr, lufenuron, hydramethylnon, sulfuramid, and hexaflumuron.
